(19) United States
(12) Patent Application Publication
(10) Pub. No.: US 2012/0163462 A1
(43) Pub. Date: Jun. 28, 2012

(54) MOTION ESTIMATION APPARATUS AND METHOD USING PREDICTION ALGORITHM BETWEEN MACROBLOCKS

(75) Inventors: Seong Mo PARK, Daejeon (KR); Young-il Kim, Daejeon (KR); Nak Woong Eum, Daejeon (KR); Hee-Bum Jung, Daejeon (KR)

(73) Assignee: ELECTRONICS AND TELECOMMUNICATIONS RESEARCH INSTITUTE, Daejeon (KR)

(21) Appl. No.: 13/315,307

(22) Filed: Dec. 9, 2011

(30) Foreign Application Priority Data
Dec. 23, 2010 (KR) 10-2010-0134039

(51) Int. Cl. H04N 7/32; H04N 7/26

(52) U.S. Cl. 375/240.16; 375/E07.125; 375/E07.243

(57) ABSTRACT

Disclosed is a motion estimation apparatus and method using a prediction algorithm between macroblocks. In the motion estimation method, an average of a motion vector of a macroblock 1 and a motion vector of a macroblock 3 is determined as a prediction motion vector. A prediction sum of absolute difference (SAD) value of the macroblock 2 is calculated, which is an SAD value based on the prediction motion vector. A reference SAD value for neighboring macroblocks of the macroblock 2 is compared with a value obtained by subtracting a predetermined threshold value from the prediction SAD value. Normal motion vector estimation is performed on the macroblock 2 based on the compared result.

### CROSS-REFERENCES TO RELATED APPLICATIONS

The present application claims priority under 35 U.S.C 119(a) to Korean Application No. 10-2010-0134039, filed on Dec. 23, 2010, in the Korean Intellectual Property Office, which is incorporated herein by reference in its entirety set forth in full.

### BACKGROUND

Exemplary embodiments of the present invention relate to a System on a Chip (SoC) design for implementing an image data compression algorithm in hardware, and more particularly, to a motion estimation apparatus and method for changing a processing order of macroblocks in an image compression algorithm and estimating a motion using a prediction algorithm between the macroblocks.

H.264 is a standard jointly developed by the Video Coding Experts Group (VCEG) of the International Telecommunications Union (ITU) and the Moving Picture Experts Group (MPEG) of the International Standard Organization (ISO), which establish international standards for moving pictures. H.264 is aimed at achieving a very high compression ratio and is a general-purpose moving picture coding technique that can be used in most transmission media such as recording media, the Internet, satellite broadcasting, etc., and in various moving picture resolution environments. Traditionally, ITU has established moving picture standards such as H.261, H.263 and H264, on the basis of wired communication media, and MPEG has standardized MPEG-1, MPEG-2 and the like as standards for processing moving pictures in recording media and broadcasting media. The MPEG has also standardized an MPEG-4 moving picture standard that is a coding standard used in all types of multimedia, and implements various functions characterized by an object-based moving picture code and a high compression ratio. After the establishment of the MPEG-4 moving picture standard, the VCEG of ITU went on to establish a moving picture standard known as H.26L with high compression performance. In MPEG's official comparison test, H.26L, having the same function as MPEG-4 (advanced simple profile), exhibited a superior compression ratio to MPEG-4. As a result of the test, the MPEG and the VCEG of ITU joined to form the Joint Video Team (JVT) and developed H.264/Advanced Video Coding (AVC) that is a moving picture standard based on H.26L. The H.264/AVC has a variety of excellent characteristics. Current markets require a SoC capable of performing processing with high image quality and high resolution. As the resolution increases, data communication between external and internal memories frequently occurs, which results in performance degradation of the entire system.

Generally, image signals have a high correlation with adjacent pictures. Therefore, motion estimation is used as an algorithm for increasing the compression ratio of image signals by reducing redundant information existing on a time axis. The motion estimation requires a large amount of calculation, and thus extensive studies on algorithms and hardware structures have been conducted. FIG. 1 illustrates a schematic configuration of a motion estimation apparatus for performing combined layer searching that uses a motion estimation skipping algorithm without diminishing image quality, as one of conventional motion estimation apparatuses.

Referring to FIG. 1, the combined motion estimation apparatus 100 includes first and second memories 101 and 102, a motion estimation skip unit 120, a coarse motion estimation unit 130, a multiplexer 140, a comparator 150, an address generator 160 and a controller 170.

The first memory 101 stores current image data Cur_DATA for obtaining a motion vector MV. The second memory 102 stores previous image data Prev_DATA used as a search region for searching a motion vector.

The coarse motion estimation unit 130 receives the current image data Cur_DATA and the previous image data Prev_DATA, respectively stored in the first and second memories 101 and 102, and performs a motion search every 2-pixels. Then, the coarse motion estimation unit 130 obtains a motion vector MV by 2-pixels. To this end, the coarse motion estimation unit 130 obtains the sum of absolute difference (SAD) values between blocks existing in the previous image data Prev_DATA inputted from the second memory 102 and outputs the SAD values to the comparator 150. The comparator 150 obtains a minimum SAD value SAD_Min from the input SAD values and outputs the minimum SAD value SAD_Min to the multiplexer 140 as the final motion vector.

Such operation of the coarse motion estimation unit 130 is selectively performed depending on whether or not motion estimation is skipped, which is determined in the motion estimation skip unit 120.

The motion estimation skip unit 120 has three motion vectors MV of a previous macroblock and top and top-right macroblocks of a current macroblock as inputs before motion estimation is normally operated, and performs a process of motion vector prediction that selects a median from the three motion vectors MV, thereby obtaining a motion vector predictor value. A motion compensator 121 obtains a sum of absolute difference motion compensation prediction (SADcmp) value by performing motion compensation using the obtained prediction vector. Simultaneously, a maximum SAD value is obtained by selecting a maximum value from input SAD values obtained from the previous macroblock and the top and top-right macroblocks.

A skip determiner 122 determines whether or not to skip a motion estimation process for the current macroblock by comparing the maximum SAD value and the SADmcp value. For example, when the SADmcp value is smaller than the maximum SAD value, motion estimation is skipped (i.e., without performing the motion estimation process performed in the coarse motion estimation unit 130), and only a motion compensation process is performed.

The conventional combined motion estimation apparatus always fetches reference image data, i.e., previous image data used as a search area for searching for a moving vector, from the outside in a motion estimation and skipping process. Therefore, extensive calculation is required, and it becomes difficult to perform real-time implementation in a moving picture encoder. Also, an additional memory is required in the inside of the apparatus, and therefore, causes a problem with area and power consumption. In addition, as a fixed algorithm is used depending on the kind of image and application fields, an unnecessary calculation amount is required, and there is a limitation in using a suitable motion estimation algorithm depending on the kind of image.

Also, the communication of multimedia data between external and internal memories increases due to an increase in resolution when an SoC is implemented using the H.264 that is a standard for multimedia moving picture compression, and therefore, the performance of the SoC is degraded.

The technical configuration described above is a background art for better understanding of the present invention, but is not a prior art well-known in the technical field pertinent to the present invention.

### SUMMARY

An embodiment of the present invention relates to a motion estimation apparatus and method capable of remarkably reducing a memory bandwidth by changing a processing order of memory blocks and omitting access to an external memory when a prediction motion vector has a small value using a prediction algorithm between the memory blocks.

In one embodiment, a motion estimation method using a prediction algorithm between macroblocks includes: determining an average of a motion vector of a macroblock 1 and a motion vector of a macroblock 3 as a prediction motion vector; calculating a prediction sum of absolute difference (SAD) value of the macroblock 2, which is an SAD value based on the prediction motion vector; comparing a reference SAD value for neighboring macroblocks of the macroblock 2 with a value obtained by subtracting a predetermined threshold value from the predicted SAD value; and selectively performing normal motion vector estimation on the macroblock 2 based on the compared result.

The macroblocks 1, 2 and 3 may be macroblocks which sequentially exist at consecutive positions and are contained in one processing group.

In the selectively performing normal motion vector estimation, the normal motion vector estimation may be omitted and the prediction motion vector may be outputted as a motion vector of the macroblock 2 when the reference SAD value is smaller than the value obtained by subtracting the predetermined threshold value from the prediction SAD value, and the normal motion vector estimation may be performed when the reference SAD value is greater than or identical to the value obtained by subtracting the predetermined threshold value from the prediction SAD value.

Calculating SAD values using three macroblocks positioned at the left, top and top-right of the macroblock 2 as the neighboring macroblocks and determining a median of the SAD values as the reference SAD value may be performed prior to the comparing of the reference SAD value for neighboring macroblocks of the macroblock 2.

The motion vector of the macroblock 1 and the motion vector of the macroblock 3 may be obtained through normal motion estimation.

In another embodiment, a motion estimation apparatus using a prediction algorithm between macroblocks includes a motion predictor configured to determine an average of a motion vector of a macroblock 1 and a motion vector of a macroblock 3 as a prediction motion vector; an SAD converter configured to calculate a prediction SAD value of the macroblock 2, which is an SAD value based on the prediction motion vector; a reference SAD calculator configured to calculate a reference SAD value for neighboring macroblocks of the macroblock 2; and a comparator configured to compare the reference value with a value obtained by subtracting a predetermined threshold value from the prediction SAD value, and selectively perform normal motion vector estimation on the macroblock 2 based on the compared result.

The macroblocks 1, 2 and 3 may be macroblocks which sequentially exist in consecutive positions and are contained in one processing group.

The comparator may omit the normal motion vector estimation and output the prediction motion vector as a motion vector of the macroblock 2 when the reference SAD value is smaller than the value obtained by subtracting the predetermined threshold value from the prediction SAD value, and may perform the normal motion vector estimation when the reference SAD value is greater than or identical to the value obtained by subtracting the predetermined threshold value from the prediction SAD value.

The reference SAD calculator may calculate SAD values using three macroblocks positioned at the left, top and top-right of the macroblock 2 as the neighboring macroblocks, and determine a median of the SAD values as the reference SAD value.

The motion vector of the macroblock 1 and the motion vector of the macroblock 3 may be obtained through normal motion estimation.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a schematic configuration block diagram of a conventional motion estimation apparatus for performing combined layer searching;

FIG. 2 illustrates a (a) conventional processing order of macroblocks for motion estimation and a (b) processing order of macroblocks for motion estimation according to the present invention;

FIG. 3 is a block diagram illustrating a schematic configuration of a motion estimation apparatus according to an embodiment of the present invention;

FIG. 4 is a block diagram illustrating a schematic configuration of a motion vector predictor according to the embodiment of the present invention;

FIG. 5 illustrates a configuration of macroblocks according to the embodiment of the present invention;

FIG. 6 is a flowchart illustrating a motion estimation method according to an embodiment of the present invention; and

FIG. 7 illustrates a (a) result obtained by calculating a memory bandwidth in motion estimation based on the conventional method and a (b) memory bandwidth in motion estimation according to the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

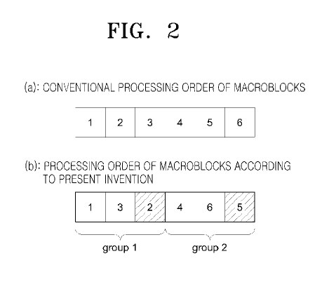

FIG. 2 illustrates a conventional processing order of conventional macroblocks for motion estimation and a processing order of macroblocks for motion estimation according to the present invention.

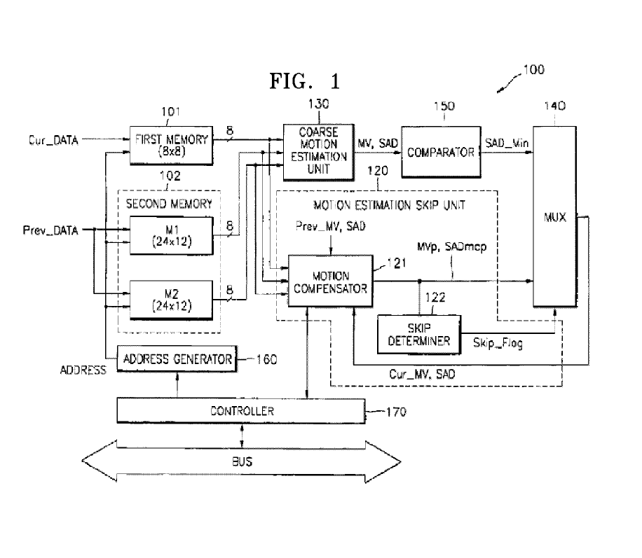

Referring to (a) of FIG. 2, there is illustrated an order in which macroblocks (MB) are processed in the conventional motion estimation apparatus 100 illustrated in FIG. 1. In the conventional processing order of macroblocks, the macroblocks are sequentially processed in the order of macroblocks 1, 2, 3, 4, 5 and 6. Therefore, the motion estimation apparatus 100 necessarily accesses an external memory (e.g., SDRAM, etc.) and require a large memory bandwidth so as to calculate a motion vector for each of the macroblocks.

However, in the present invention, macroblocks can be processed by being divided into groups each having three macroblocks, such as a first group (group 1) and a second group (group 2), as illustrated in (b) of FIG. 2.

Among three macroblocks belonging to one processing group (e.g., the first group), motion vectors of first and third macroblocks (macroblocks 1 and 3) are normally estimated. Then, a prediction algorithm using the estimated motion vectors of the first and third macroblocks is applied to a second macroblock (macroblock 2 in the first group), so that normal motion vector estimation required to access the external memory is selectively performed, thereby reducing a memory bandwidth in high-resolution image processing.

Hereinafter, the motion estimation apparatus and method according to the present invention will be described in detail based on the first group (group 1) in the macroblock processing order illustrated in (b) of FIG. 2.

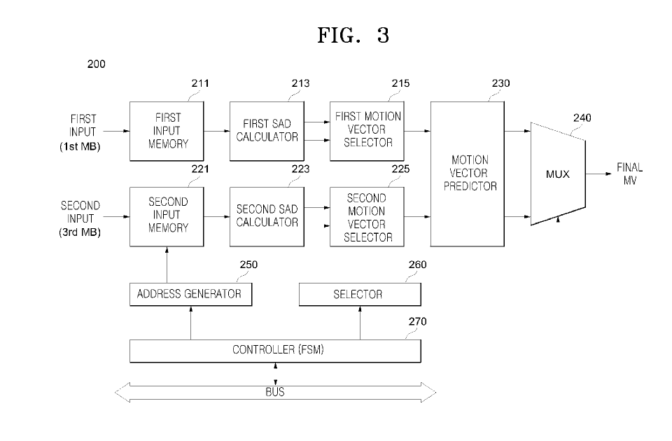

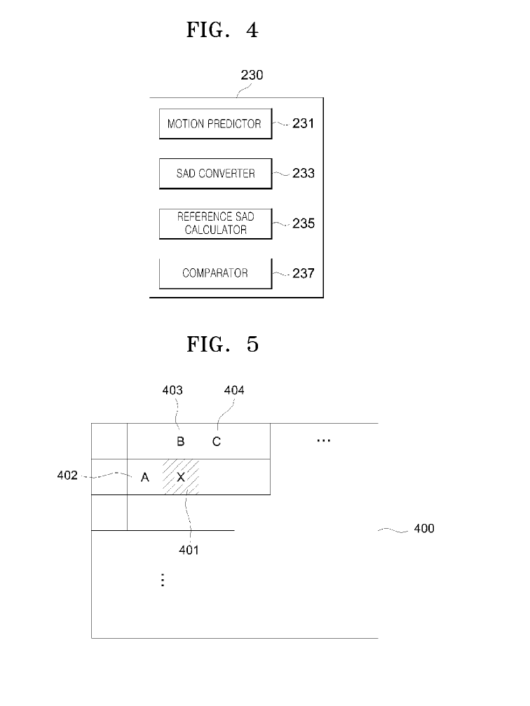

FIG. 3 is a block diagram illustrating a schematic configuration of a motion estimation apparatus according to an embodiment of the present invention. FIG. 4 is a block diagram illustrating a schematic configuration of a motion vector predictor according to the embodiment of the present invention. FIG. 5 illustrates a configuration of macroblocks according to the embodiment of the present invention.

The motion estimation apparatus 200 according to this embodiment performs normal motion vector estimation on the motion vectors of the first macroblock (MB 1) and third macroblock (MB 3), and the normal motion vector estimation is selectively performed by the prediction algorithm to the second macroblock, thereby reducing the access to the external memory.

Referring to FIG. 3, the motion estimation apparatus 200 according to this embodiment includes first and second input memories 211 and 221, first and second SAD calculators 213 and 223, first and second motion vector selectors 215 and 225, a motion vector predictor 230, a multiplexer 240, an address generator 250, a selector 260 and a controller 270.

The first input memory 211 stores image data corresponding to the first macroblock (MB 1).

The first SAD calculator 213 calculates SAD values in a search area for searching for a motion vector from a previous image frame with respect to the first macroblock (MB 1) stored in the first input memory 211. For example, the SAD values may be obtained by comparing, one by one, pixels positioned in a corresponding block of a current image with pixels positioned in a block area with the same size, which exists in the search area of a previous image, i.e., by summing differences in size between pixels corresponding to each other.

The first motion vector selector 215 obtains a minimum value from the SAD values calculated in the first SAD calculator 213, and outputs a dislocation of the first macroblock and the block area in the search area of the previous image, corresponding to the minimum value, as a motion vector (MVa) of the first macroblock (MB 1) to the motion vector predictor 230.

The second input memory 221 stores image data corresponding to the third macroblock (MB 3).

The second SAD calculator 223 calculates SAD values in the search area for searching for the motion vector from the previous image frame with respect to the third macroblock (MB 3) stored in the second input memory 221. For example, the SAD values may be obtained by comparing, one by one, pixels positioned in a corresponding block of the current image with pixels positioned in a block area with the same size, which exists in the search area of the previous image, i.e., by summing differences in size between pixels corresponding to each other.

The second motion vector selector 225 obtains a minimum value from the SAD values calculated in the second SAD calculator 223, and outputs a dislocation of the third macroblock and the block area in the search area of the previous image, corresponding to the minimum value, as a motion vector (MVb) of the third macroblock (MB 3) to the motion vector predictor 230.

The motion vector predictor 230 predicts a motion vector of the current macroblock (second macroblock (MB 2)) through the prediction algorithm using the values respectively outputted from the first and second motion vector selectors 215 and 225.

Referring to FIG. 4, the motion vector predictor 230 includes a motion predictor 231, an SAD converter 233, a reference SAD calculator 235 and a comparator 237.

The motion predictor 231 calculates the motion vector (MVa) of the first macroblock, inputted from the first motion vector selector 215, and the motion vector (MVb) of the third macroblock, inputted from the second motion vector selector 225, as a prediction motion vector (MVavg) of the second macroblock.

The SAD converter 233 converts the prediction motion vector (MVavg) into a prediction SAD value (SADavg) by calculating SAD values using the prediction motion vector of the second macroblock, calculated in the motion predictor 231. The calculation of the SAD values may be performed by obtaining the sum of absolute values of pixels in the second macroblock of the current image frame and pixels in a block area with the same size, which exists at a position changed by the prediction motion vector (MVavg) from the same position as the second macroblock.

The reference SAD calculator 235 calculates a reference SAD value that is a median of SAD values of neighboring macroblocks with respect to the second macroblock (MB 2).

As illustrated in FIG. 5, in a previous image frame 400, an X block 401 may be a block existing at the same position as the second macroblock (MB 2), and neighboring blocks may be an A block 402 at the left of the X block 401, a B block 403 at the top of the X block 401 and a C block 404 at to top-right of the X block 401. Thus, SAD values SADa, SDAb and SADc of the respective A, B and C blocks 402, 403 and 404 are calculated, and a median of the SAD values is determined as a reference SAD value (See the following Expression 1).

Reference SAD=Median{SADa, SADb, SADc} Expression 1

The comparator 237 determines the prediction motion vector MVavg or a normal prediction motion vector (MVnp) as the motion vector of the second macroblock by comparing the reference SAD value outputted from the reference SAD calculator 235 with a value obtained by subtracting a predetermined threshold value (Th) from the prediction SAD value (SADavg) outputted from the SAD converter 233. Here, the normal prediction motion vector (MVnp) is a motion vector estimated through a normal process identical to that performed on the first macroblock (MV 1) or third macroblock (MV 3). The normal prediction motion vector (MVnp) may be obtained by calculating SAD values of all block areas with the same size as a macroblock positioned in the search area of the previous image frame, obtaining a minimum value from the SAD values and then calculating a vector from a dislocation of a macroblock and a block area, corresponding to the minimum value. The predetermined threshold value (Th) may be determined as, for example, 100 using an experimental or statistical method.

In a case where the value (SADavg−Th) obtained by subtracting the predetermined threshold value from the prediction SAD value is smaller than the reference SAD value, the normal motion estimation is omitted, and the prediction motion vector (MVavg) calculated in the motion predictor 231 is outputted as the motion vector of the second macroblock. In a case where the value (SADavg−Th) obtained by subtracting the predetermined threshold value from the prediction SAD value is greater than or identical to the reference SAD value, the normal prediction motion vector (MVnp) selected by performing the normal motion estimation is outputted as the motion vector of the second macroblock.

Referring back to FIG. 3, the multiplexer 240 outputs the prediction motion vector (MVavg) or the normal prediction motion vector (MVnp), outputted from the motion vector predictor 230, as the motion vector of the second macroblock (MB 2) depending on a flag value set by the selector 260.

The selector 260 sets a flag for determining an output value of the multiplexer 240 based on a result compared in the comparator 237. In a case where the value (SADavg−Th) obtained by subtracting the predetermined threshold value from the prediction SAD value is smaller than the reference SAD value, the selector 260 sets the flag as 0 or 1 so that the prediction motion vector (MVavg) is outputted. In a case where the value (SADavg−Th) obtained by subtracting the predetermined threshold value from the prediction SAD value is greater than or identical to the reference SAD value, the selector 260 sets the flag as 1 or 0 so that the normal prediction motion vector (MVnp) is outputted.

The controller 270 controls an operation of the address generator 250 based on the result determined in the motion vector predictor 230. The controller 270 controls a general operation of the motion estimation apparatus 200, and performs an interface with a bus at the same time.

The address generator 250 generates addresses related to the motion estimation and motion prediction to the first and second memories 211 and 221 under the control of the controller 270.

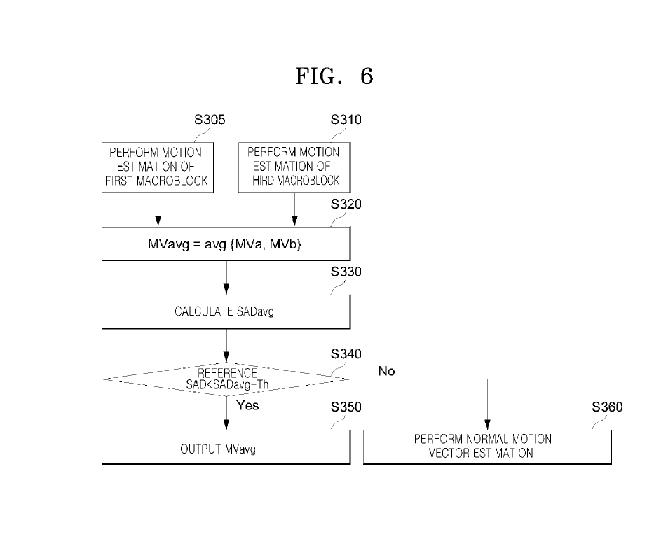

FIG. 6 is a flowchart illustrating a motion estimation method according to an embodiment of the present invention.

Here, each step may be performed by the motion estimation apparatus 200, particularly each of the components in the motion vector predictor 230.

First, the motion vector predictor 230 receives a first motion vector (MVa) that is a motion estimation result of the first macroblock (MB 1) from the first motion vector selector 215 (S305), and receives a second motion vector (MVb) that is a motion estimation result of the third macroblock (MB 3) from the second motion vector selector 225 (S310).

The motion predictor 231 determines an average of the first and second motion vectors (MVa and MVb) as a prediction motion vector (MVavg) of the second macroblock (MB 2) positioned in the middle in the group (S320).

The SAD converter 233 calculates a prediction SAD value (SADavg) that is an SAD value of the second macroblock (MB 2) using the prediction motion vector (MVavg) (S330).

The comparator 237 compares a reference SAD value with a value obtained by subtracting a predetermined value (Th) from the calculated prediction SAD value (SADavg) (S340).

In a case where the reference SAD value is greater than or identical to the value obtained by subtracting the predetermined value (Th) from the calculated prediction SAD value (SADavg), a motion vector is obtained by performing normal motion estimation on the second macroblock (S360). However, in a case where the reference SAD value is smaller than the value obtained by subtracting the predetermined value (Th) from the calculated prediction SAD value (SADavg), the prediction motion vector (MVavg) is determined and outputted as the motion vector of the second macroblock (S350). Accordingly, the normal motion estimation that requires access to an external memory can be omitted, thereby preventing degradation of system performance.

It will be apparent that the motion estimation method described above may be performed by a software program embedded in the motion vector predictor, etc. using an automated procedure according to a time-series order. Codes and code segments constituting the programs may be easily construed by computer programmers skilled in the art to which the invention pertains. Furthermore, the created program may be stored in computer-readable recording media or data storage media and may be read out and executed by the computers. Examples of the computer-readable recording media include magnetic storage media, optical recording media and carrier wave media.

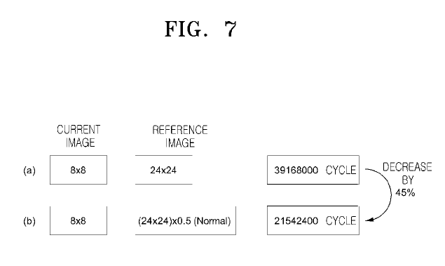

FIG. 7 illustrates a result obtained by calculating a memory bandwidth in motion estimation based on the conventional method and a memory bandwidth in motion estimation according to the present invention.

It is assumed that the bus has a structure in which the data bandwidth per frame is 32 bits. According to the conventional motion estimation, data of a search area with a size of 24×24 in a reference image frame is required with respect to a macroblock with a size of 8×8 in a current image frame, and therefore, 39168000(=(64+576)×8160/4×30 fps) cycles are required.

According to the present invention, the normal motion prediction is omitted as a 50% probability with respect to the macroblock with the size of 8×8 in the current image frame. When the motion prediction is succeeded, about ½ of the data of the search area with the size of 24×24 in the reference image frame is accessed, and thus 21542400(=(64×8160+576×8160)/4×30 fps) cycles are required. That is, in the motion estimation apparatus and method according to the present invention, the memory bandwidth is decreased by about 45% as compared with the conventional motion estimation apparatus and method.

As described above, according to the present invention, H.264 motion prediction can be implemented by changing a processing order of memory blocks and omitting access to an external memory (e.g., SDRAM, etc.) when a prediction motion vector has a small value using a prediction algorithm between the memory blocks. Further, the memory bandwidth can be remarkably reduced in high-resolution image processing. Furthermore, an essential core technology can be used in portable multimedia terminals and the like, which require low power.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A motion estimation method using a prediction algorithm between macroblocks, the method comprising:
determining an average of a motion vector for macroblock 1 and a motion vector for macroblock 3 to make a prediction motion vector;
calculating a prediction sum of absolute difference (SAD) value of macroblock 2, which is an SAD value based on the prediction motion vector;
comparing a reference SAD value for neighboring macroblocks of the macroblock 2 with a value obtained by subtracting a predetermined threshold value from the prediction SAD value; and
selectively performing normal motion vector estimation on the macroblock 2 based on the compared result.

2. The method of claim 1, wherein the macroblocks 1, 2 and 3 are macroblocks which sequentially positioned and are contained in one processing group.

3. The method of claim 1, wherein in the selectively performing normal motion vector estimation, the normal motion vector estimation is omitted and the prediction motion vector is outputted as a motion vector of the macroblock 2 when the reference SAD value is smaller than the value obtained by subtracting the predetermined threshold value from the prediction SAD value, and the normal motion vector estimation is performed when the reference SAD value is greater than or identical to the value obtained by subtracting the predetermined threshold value from the prediction SAD value.

4. The method of claim 1, wherein calculating SAD values using three macroblocks positioned at the left, top and top-right of the macroblock 2 as the neighboring macroblocks and determining a median of the SAD values as the reference SAD value is performed prior to the comparing of the reference SAD value for neighboring macroblocks of the macroblock 2.

5. The method of claim 1, wherein the motion vector of the macroblock 1 and the motion vector of the macroblock 3 are obtained through normal motion estimation.

6. A motion estimation apparatus using a prediction algorithm between macroblocks, the apparatus comprising:
a motion predictor configured to determine an average of a motion vector for a macroblock 1 and a motion vector for a macroblock 3 to make a prediction motion vector;
an SAD converter configured to calculate a prediction SAD value of the macroblock 2, which is an SAD value based on the prediction motion vector;
a reference SAD calculator configured to calculate a reference SAD value for neighboring macroblocks of the macroblock 2; and
a comparator configured to compare the reference SAD value with a value obtained by subtracting a predetermined threshold value from the prediction SAD value, and selectively perform normal motion vector estimation on the macroblock 2 based on the compared result.

7. The apparatus of claim 6, wherein the macroblocks 1, 2 and 3 are macroblocks which sequentially positioned and are contained in one processing group.

8. The apparatus of claim 6, wherein the comparator omits the normal motion vector estimation and outputs the prediction motion vector as a motion vector of the macroblock 2 when the reference SAD value is smaller than the value obtained by subtracting the predetermined threshold value from the prediction SAD value, and performs the normal motion vector estimation when the reference SAD value is greater than or identical to the value obtained by subtracting the predetermined threshold value from the prediction SAD value.

9. The apparatus of claim 6, wherein the reference SAD calculator calculates SAD values using three macroblocks positioned at the left, top and top-right of the macroblock 2 as the neighboring macroblocks, and determines a median of the SAD values as the reference SAD value.

10. The apparatus of claim 6, wherein the motion vector of the macroblock 1 and the motion vector of the macroblock 3 are obtained through normal motion estimation.
